(19) United States
(12) Patent Application Publication
(10) Pub. No.: US 2001/0033220 A1
(43) Pub. Date: Oct. 25, 2001

(54) Security control method and system

(76) Inventors: Robert T. Stone, Sunnyvale, CA (US); Bret A. Herscher, Cupertino, CA (US)

Correspondence Address: FRANCIS LAW GROUP, 1808 SANTA CLARA AVE, ALAMEDA, CA, 94501, US

(21) Appl. No.: 09/782,770

(22) Filed: Feb. 13, 2001

Related U.S. Application Data
(60) Provisional application No. 60/182,278, filed on Feb. 14, 2000.

(51) Int. Cl. H04Q 1/00; G06F 7/00

(52) U.S. Cl. 340/5.52; 340/5.53

(57) ABSTRACT

A system and method for verifying an individual's identity that collects fingerprint information and verifies it using blood oxygen saturation and/or ECG information. The results of the identification can be used to control access and may be output to a security monitor.

### CROSS REFERENCE TO RELATED APPLICATIONS

This application claims benefit under 35 U.S.C. 119 (e) of U.S. Provisional Application No. 60/182,278, filed Feb. 14, 2000.

### FIELD OF THE INVENTION

The present invention relates generally to security control methods and systems. More particularly, the invention relates to a security control method and system that employs a plurality of personal descriptors.

### BACKGROUND OF THE INVENTION

The recent dramatic increases in industrial espionage, terrorism and employee dishonesty have caused many industrial and governmental organizations to carefully reexamine the security procedures by which employees, business invitees and guests are admitted to restricted premises. Governmental organizations are also reexamining the security procedures by which personnel have access to and control of highly sensitive devices.

These studies have demonstrated that the most commonly used personnel access control technique, the conventional photo-ID card, is not very effective due to the relative ease by which such ID cards can be forged or altered, especially by experienced criminals or trained terrorists. As a result of the limitations of conventional photo ID cards, many organizations have implemented more sophisticated access control systems which rely on personal descriptors, such as the employees' voice print, retinal image, fingerprints, signature, etc. Illustrative are the systems disclosed in U.S. Pat. Nos. 4,109,237; 3,989,896; 4,053,228; and 3,928,842.

Unfortunately, such systems do not offer the degree of security that was originally hoped for because experience has shown that the human voice can be imitated; that fingerprints can be surreptitiously “lifted” and recreated in latex; and that signatures can be forged.

It is therefore an object of the present invention to provide an identification system that offers greater accuracy than prior art systems.

It is another object of the invention to provide an identification system that offers one or more verifications of information corresponding to a personal descriptor.

It is yet another object of the invention to provide a fingerprint identification system that offers blood oxygen saturation and/or ECG verification of the fingerprint information.

### SUMMARY OF THE INVENTION

In accordance with the above objects and those that will be mentioned and will become apparent below, the invention comprises a system for verifying an individual's identity including a sensor, first and second security modules comprising first and second personal descriptor detectors, a memory that stores personal descriptor information; and a processor which is capable of comparing stored personal descriptor information with information from the security modules. Preferably, the first personal descriptor detector comprises a fingerprint identifier and the second personal descriptor detector comprises a blood oxygen saturation verifier. The second personal descriptor detector collects information capable of verifying information from the first personal descriptor detector.

In a further embodiment of the invention, the system also includes a third security module comprising a third personal descriptor detector. Preferably, the third personal descriptor detector comprises an ECG verifier.

In another embodiment of the invention, the system also includes a control device responsive to the processor, which may comprise, for example, a door release, a computer access control, or a weapon lock. The invention may also comprise a security monitor for displaying the results of the identification and verification processes.

The invention also comprises a method of verifying an individual's identity comprising the steps of collecting information corresponding to first and second personal descriptors, identifying the individual by comparing the information corresponding to the first personal descriptor with stored personal descriptor information; and verifying the information corresponding to the first personal descriptor with information from the second personal descriptor. Preferably, the method comprises extracting fingerprint information and measuring blood oxygen saturation. The verification step preferably includes verification that the blood oxygen saturation surpasses a threshold. In addition, the threshold can be adjusted to compensate for environmental conditions. Optionally, the method may also comprise the step of collecting information corresponding to a third personal descriptor, such as ECG information, and using that information for further verification. The methods of the invention also comprise controlling access devices and outputting the identification and verification information.

### BRIEF DESCRIPTION OF THE DRAWINGS

Further features and advantages will become apparent from the following and more particular description of the preferred embodiments of the invention, as illustrated in the accompanying drawings, and in which like referenced characters generally refer to the same parts or elements throughout the views, and in which:

FIG. 1 is a schematic diagram of the system of the invention.

### DETAILED DESCRIPTION OF THE INVENTION

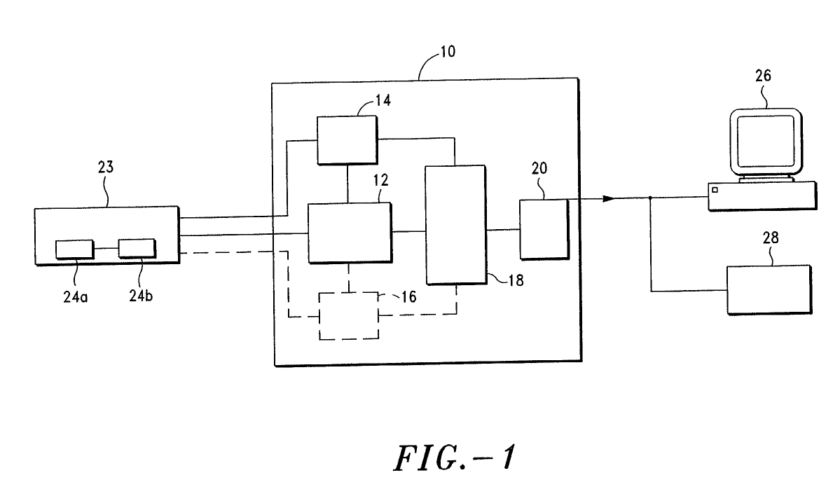

Referring to FIG. 1, in one embodiment of the invention, the security system 10 includes a first security module 12 having a fingerprint identifier and a second module 14 having blood oxygen verifier. As illustrated in FIG. 1, a memory 18 and processor 20, such as a microprocessor, are also provided to store, process and analyze personal descriptors. The first security module 12, the second security module 14 and the memory 18 are all in communication with the processor 20, by wired or wireless connections.

According to the invention, the fingerprint identifier is designed and adapted to automatically identify and extract from the fingerprint patterns specific information, such as ridge control data, describing the ridge flow in the fingerprint pattern, and minutia data, principally describing ridge endings and bifurcations. Topological data identifying singularity points, such as tri-radii and cores, as well as ridge flow line tracings related to those identified singularity points, are also automatically extracted from the ridge contour data.

The extracted fingerprint information is then automatically classified and matched with fingerprint patterns stored in the memory 18. Identification is then automatically achieved via the processor 18 by comparing the extracted fingerprint information with the information stored in the memory 18 which corresponds to previously identified fingerprint patterns.

According to the invention, various conventional fingerprint identification systems may be employed within the scope of the invention. Such technology includes the optical fingerprint identification methods and systems disclosed in U.S. Pat. Nos. 4, 151,512 and 4,053,228, which are incorporated by reference therein.

To ensure that the fingerprint information acquired by the first module 12 has not been extracted from a severed finger (or other appendage) or a fingerprint that has been lifted or recreated in latex (i.e., obtained from a live being), a second module 14 having blood oxygen verifier is provided. According to the invention, the blood oxygen verifier comprises non-evasive system for determining an individual's blood oxygen saturation (SaO₂).

Various non-evasive blood oxygen verifiers may be employed within the scope of the invention to extract the blood oxygen saturation information from an individual. For example, the absorbence oximeter disclosed in U.S. Pat. No. 4,167,331, which is incorporated by reference herein, is suitable for the practice of the invention.

As will be appreciated by one having skill in the art, the blood oxygen saturation information provides reliable information indicative of whether the fingerprint was extracted from a live being. Indeed, it is well known that the oxygen saturation of a “live” being is typically greater than 95%. The indicated oxygen saturation from an artificial or non-arterial pulsation will typically be about 81% in typical pulse oximeters which utilize light emitting diodes in the red and infra-red wavelengths.

Accordingly, if the extracted fingerprint information matches information in the memory 18 and a blood oxygen saturation reading greater than 85% is obtained, the processor of the invention would provide at least a first output signal indicative of the individual's authorization. According to the invention, in response to the first output signal, a security monitor 26 (if employed) provides a visual indication of the authorization, such as an illuminated green light or the wording “authorized.” If a control device, such as a release on a door or a “safety” on a weapon, is operatively connected to or in communication with the security system 10, the control device would be de-activated or released in response to the first output signal.

If an oxygen saturation reading less than 81% (i.e., threshold reference) is obtained from the second security module 14, it is highly probable that the fingerprint information was obtained from a latex fingerprint or a fingerprint obtained from a severed finger. The processor would thus provide at least one second output signal indicative of the identity of the individual matching the extracted fingerprint information, if contained in the memory, and the attempt to circumvent the system 10. If a security monitor 26 is employed, the monitor 26 would display the noted information, and any desired additional warnings, in response to the second output signal.

Since it is well known in the art that the blood oxygen saturation will decrease as altitude or atmospheric pressure increases, in an additional envision embodiment of the invention, the second security module 14 would further include a pressure correction or compensation. According to the invention, the pressure correction would adjust the threshold oxygen saturation reference (i.e., 81%) to account for the atmospheric pressure changes. Alternatively, other environmental conditions may be accounted for when analyzing the information from the security modules to correct for environmental conditions if appropriate.

In yet another envisioned embodiment of the invention, the system includes a third security module 16 in communication with processor 20. Preferably, the third security module 16 comprises an ECG (electrocardiography) verifier. As will be appreciated by one having skill in the art, the ECG verifier provides an additional layer of security.

According to the invention, the ECG verifier extracts distinguishable characteristics relating to the electric current (or potential) generated by the heart. Such information includes the three readily identifiable waveforms of a cardiac cycle: the P wave, the QRS complex and the T wave. The P wave depicts atrial depolarization; the QRS complex, ventricular depolarization; and the T wave, ventricular repolarization.

Various ECG verifier may be employed within the scope of the invention. In a preferred embodiment, the ECG verifier comprises correlation of the heart rate as determined by the ECG and the heart rate as determined by the optical pulse oximetry signals.

As illustrated in FIG. 1, the ECG information is similarly transmitted to the memory 18 of the system 10. The processor 20 then additionally compares the ECG information to the information stored in the memory 18.

Referring to FIG. 1, in operation, a subject initially places his/her finger on the SaO₂ pad 24a of the entry terminal 23. While the finger is positioned on the pad 24a, the fingerprint is scanned and the blood oxygen saturation is determined.

As discussed in detail above, in an additional embodiment of the invention, ECG information can also be extracted by simultaneously placing a second finger on the opposing hand on the ECG verification pad 24b.

The information extracted by the security modules 12, 14, 16 is transmitted to the system memory 18. The information is then compared to the personal descriptor data stored in memory 18 via the processor 20 of the system 10.

Output from the processor 20 is then preferably provided to a security monitor 26 or directly to a control device 28. Such control devices include, but are not limited to, a door release, computer system access and/or a “safety” for a weapon or weapon system.

As will be appreciated by one having skill in the art, the level of security provided by the invention is unparalleled in the art. The method and system could thus be employed to control access to sensitive areas and/or to control operation of sensitive devices, such as computers, weapons, etc.

Without departing from the spirit and scope of this invention, one of ordinary skill can make various changes and modifications to the invention to adapt it to various usages and conditions. As such, these changes and modifications are properly, equitably, and intended to be, within the full range of equivalence of the following claims.

What is claimed is:

1. A system for verifying an individual's identity comprising:
a) a first sensor;
b) a first security module in communication with the first sensor comprising a first personal descriptor detector;
c) a second security module in communication with the first sensor comprising a second personal descriptor detector;
d) a memory that stores personal descriptor information; and
e) a processor in communication with the first and second security modules and the memory which is capable of comparing stored personal descriptor information with information from the security modules.

2. The system of claim 1, wherein the first personal descriptor detector comprises a fingerprint identifier.

3. The system of claim 2, wherein the fingerprint identifier collects information comprising ridge control data and minutia control data.

4. The system of claim 3, wherein ridge control data comprises ridge flow and wherein minutia control data comprises ridge endings and bifurcations.

5. The system of claim 4, wherein the information collected by the fingerprint further comprises singularity points and related ridge flow line tracings.

6. The system of claim 1, wherein the second personal descriptor detector collects information capable of verifying information from the first personal descriptor detector.

7. The system of claim 6, wherein the second personal descriptor detector comprises a blood oxygen saturation verifier.

8. The system of claim 7, wherein the blood oxygen saturation verifier comprises an absorbance oximeter.

9. The system of claim 1, further comprising a third security module comprising a third personal descriptor detector in communication with the processor.

10. The system of claim 9, wherein the third personal descriptor detector is in communication with the first sensor and a second sensor.

11. The system of claim 10, wherein the third personal descriptor detector comprises an ECG verifier.

12. The system of claim 10, wherein the ECG verifier is capable of collecting P wave, QRS complex and T wave information.

13. The system of claim 1, further comprising a control device responsive to the processor.

14. The system of claim 13, wherein the control device comprises a door release.

15. The system of claim 13, wherein the control device comprises a computer access control.

16. The system of claim 13, wherein the control device comprises a weapon lock.

17. The system of claim 1, further comprising a security monitor in communication with the processor.

18. The system of claim 2, wherein the second personal descriptor detector comprises a blood oxygen saturation verifier.

19. The system of claim 18, further comprising a control device responsive to the processor.

20. The system of claim 19, further comprising a security monitor in communication with the processor.

21. The system of claim 20, further comprising an ECG verifier in communication with the processor and a second sensor.

22. A method of verifying an individual's identity comprising the steps of:
a) collecting information corresponding to a first personal descriptor;
b) collecting information corresponding to a second personal descriptor;
c) identifying the individual's identity by comparing the information corresponding to the first personal descriptor with stored personal descriptor information; and
d) verifying the information corresponding to the first personal descriptor with information from the second personal descriptor.

23. The method of claim 22, wherein the step of collecting information corresponding to a first personal descriptor comprises extracting fingerprint information.

24. The method of claim 23, wherein the step of collecting information corresponding to a second personal descriptor comprises measuring blood oxygen saturation.

25. The method of claim 24, wherein the step of verifying the fingerprint information with the blood oxygen saturation comprises verifying that the blood oxygen saturation surpasses a threshold.

26. The method of claim 25, wherein the step of verifying that the blood oxygen saturation surpasses a threshold comprises verifying that the blood oxygen saturation is greater than about 85%.

27. The method of claim 25, further comprising the step of adjusting the threshold to compensate for environmental conditions.

28. The method of claim 22, further comprising the step of using the comparison of the information corresponding to the first personal descriptor with stored personal descriptor information and the verification of the information corresponding to the first personal descriptor with information from the second personal descriptor to control a device.

29. The method of claim 28, wherein the step of collecting information corresponding to a first personal descriptor comprises extracting fingerprint information and the step of collecting information corresponding to a second personal descriptor comprises measuring blood oxygen saturation.

30. The method of claim 29, further comprising the step of outputting the results of the comparison of the fingerprint information with stored personal descriptor information and the verification of the fingerprint information to a monitor.

31. The method of claim 22, further comprising the steps of collecting information corresponding to a third personal descriptor and verifying the information corresponding to the second personal descriptor with information from the third personal descriptor.

32. The method of claim 31, wherein the step of collecting information corresponding to the third personal descriptor comprises measuring ECG characteristics.

33. The method of claim 29, further comprising the steps of collecting ECG information and verifying the fingerprint information with the ECG information.
